(19) United States
(12) Patent Application Publication
(10) Pub. No.: US 2025/0150107 A1
(43) Pub. Date: May 8, 2025

(54) Removable Hands-Free Phone-Holding Device

(71) Applicant: Jennifer Tran, New York, NY (US)

(72) Inventor: Jennifer Tran, New York, NY (US)

(21) Appl. No.: 18/921,158

(22) Filed: Oct. 21, 2024

Related U.S. Application Data
(60) Provisional application No. 63/595,970, filed on Nov. 3, 2023.

(51) Int. Cl. H04B 1/3877; H04M 1/04

(52) U.S. Cl. CPC H04B 1/3877; H04M 1/04; H04M 2201/08

(57) ABSTRACT

An accessory for temporarily holding a handheld electronic device. The accessory is a handheld electronic device holder configured to secure to a back of the handheld electronic device on one side. The other side of the handheld electronic device holder is removably attachable to a desired mounting surface allowing a user to operate the handheld electronic device in a handsfree configuration. The handheld electronic device holder is removably attachable to both the handheld electronic device and the desired mounting surface without damaging either.

### CROSS-REFERENCE TO RELATED APPLICATION

The present application claims priority to, and the benefit of, U.S. Provisional Application No. 63/595,970, which was filed on Nov. 3, 2023, and is incorporated herein by reference in its entirety.

### BACKGROUND

The present invention generally relates to the field of cell phone attachments, and more specifically to a removable hands-free phone-holding device featuring fasteners that enables a phone to be used in a hands-free manner. The fasteners allow for attachment of a cell phone to the removable hands-free phone-holding device, as well as attachment of the removable hands-free phone-holding device to various surfaces, suspending the cell phone off the surfaces. Accordingly, the present specification makes specific reference thereto. However, it is to be appreciated that aspects of the present invention are also equally amenable to other like applications, devices, and methods of manufacture.

Cell phone attachment devices can serve various purposes and are used in different ways depending on their functionality and design. Attachments that allow for the mounting of a phone to another object or surface can be particularly advantageous, as they allow the phone to be used in a hands-free manner. However, most phone attachments that allow for mounting of the phone to another object or surface typically require permanent adhesives applied to the phone, the surface, or both. These adhesive mounts are often difficult or impossible to remove and can potentially leave unsightly residue on phones or phone cases.

Smart phone and other handheld electronic device accessories include any hardware that is not integral to the operation of a mobile electronic device as designed by the manufacturer. These accessory devices serve protect the electronic device from being damaged or to use for more convenient use of the electronic device. Cases, which are designed to attach to, support, or otherwise hold a smartphone, are popular accessories. Holsters are commonly used as external cases for devices and are made of plastic. Functional cases can integrate external batteries, a USB, Bluetooth®, a keyboard, or a touchpad.

A kickstand case is designed to keep the device standing upright. The kickstand holds the electronic device in a flatter or steeper angle, depending on whether it is horizontally placed on a surface clockwise or counterclockwise. The flat angle allows tapping without pushing the electronic device over, while the steep angle is intended for watching. External cases and design covers can serve for protection and personalization. Selfie sticks are hand-held extensible monopods used to move the electronic devices further away than would have been possible with the reach of the human arm, allowing for the camera to take shots to be taken at angles that would not have been possible before.

Mobile phone use while driving is common but it is dangerous due to its high potential for causing distracted driving and subsequent crashes. Due to the number of accidents that are related to conducting calls on a phone and texting while driving, some jurisdictions have made the use of a phone while driving illegal in an attempt to curb the practice. In response, mobile phone mounting devices have been created specifically to secure the electronic device to a vehicle while driving. However, while there are many phone securing devices for a variety of different applications, there are limited options to temporarily secure a handheld electronic device to a flat vertical surface without causing some damage to the surface.

Accordingly, there exists a long-felt need in the art for an improved removable hands-free phone-holding device. More specifically, there exists a long-felt need in the art for a removable hands-free phone-holding device that allows for removable attachment to a handheld electronic device and also to a surface. Furthermore, there exists a long-felt need in the art for a removable hands-free phone-holding device that does not leave behind residue on a handheld electronic device its case.

In this manner, the improved removable hands-free phone-holding device of the present invention accomplishes all the forgoing objectives and provides an improved mobile electronic device holder that allows for the hands-free use of the mobile electronic device. More specifically, the removable hands-free phone-holding device provides a device that is removably attachable to a phone and also separately to a surface. Furthermore, the removable hands-free phone-holding device provides users with a phone attachment that does not leave unsightly residue on phones or phone cases.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a handheld electronic device holder for removable securing a handheld electronic device to a surface. The handheld electronic device holder comprises a top, a bottom, and a pair of sides. The handheld electronic device holder further comprises a front surface and a back surface. The front surface comprises a plurality of front securing elements. The back surface comprises a plurality of back securing elements.

The front securing elements are configured to removably attach the front surface of the handheld electronic device holder to the handheld electronic device. The back securing elements are configured to removably attach the back surface of the handheld electronic device holder to the surface. The plurality of front and back securing elements may comprise suction cups, adhesive fasteners, magnetic fasteners, hook and loop fasteners, or the like.

The top may comprise a notch or a cutout configured to fit around a camera of the handheld electronic device. The handheld electronic device holder may further comprise a pocket. The pocket is disposed between the front and back surfaces and is open at the top of the handheld electronic device holder. The pocket is configured to hold flat objects, such as folded money, credit cards, identification cards, and the like.

The handheld electronic device holder may further comprise a strap for carrying the handheld electronic device holder. The handheld electronic device holder may further comprise and indicia or a reflective element. The handheld electronic device holder may further comprise a lighting element and a battery in electric communication with the battery.

Accordingly, handheld electronic device holder of the present invention is particularly advantageous as it provides a device that allows users to use phones in a hands-free manner. More specifically, the handheld electronic device holder provides a device that is removably attachable to both a handheld electronic device and to various surfaces without leaving residue upon removal. In this manner, the handheld electronic device holder provides a hands-free handheld electronic device-holding solution.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a handheld electronic device holder of the present invention removably attached to a handheld electronic device in accordance with the disclosed architecture.

FIG. 2 illustrates a side view of the handheld electronic device holder of the present invention in accordance with the disclosed architecture.

FIG. 3 illustrates a front view of the handheld electronic device holder of the present invention in accordance with the disclosed architecture.

FIG. 4 illustrates a front view of the handheld electronic device holder of the present invention in accordance with the disclosed architecture.

FIG. 5 illustrates a side view of the handheld electronic device holder of the present invention in accordance with the disclosed architecture.

FIG. 6 illustrates a perspective view of the handheld electronic device holder of the present invention in accordance with the disclosed architecture.

FIG. 7 illustrates a side view of the handheld electronic device holder of the present invention in accordance with the disclosed architecture.

FIG. 8 illustrates a rear view of the handheld electronic device holder of the present invention in accordance with the disclosed architecture.

FIG. 9 illustrates a front view of the handheld electronic device holder of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved removable hands-free phone-holding device. More specifically, there exists a long-felt need in the art for a removable hands-free phone-holding device that allows for removable attachment of the device to a phone and also separately to a surface. Furthermore, there exists a long-felt need in the art for a removable hands-free phone-holding device that does not leave behind residue on phones or phone cases.

The subject matter disclosed and claimed herein, in one embodiment thereof, comprises a removable hands-free phone-holding device. The device is generally rectangular in shape and has a front and back surface. During use, the device is designed to be removably attached to a smart phone as well as a desired mounting surface such as a wall, mirror, or window. Fasteners are attached to or integrated within both the front and back surfaces. The fasteners of the back surface engage a phone, and the fasteners of the front surface engage the desired surface from which the phone will be suspended.

Accordingly, the removable hands-free phone-holding device of the present invention is particularly advantageous as it provides a device that allows users to use smart phones in a hands-free manner by suspending them from a multitude of surfaces. More specifically, the removable hands-free phone-holding device provides a device that is removably attachable to both phones and various surfaces without leaving any unsightly residue upon removal. In this manner, the removable hands-free phone-holding device provides a hands-free phone experience unmatched by the prior art.

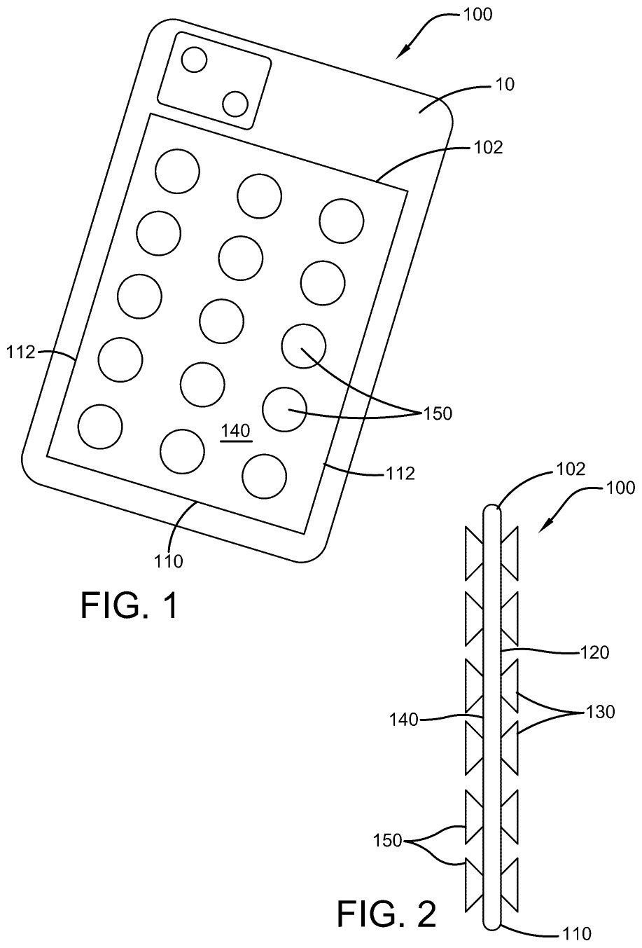

Referring initially to the drawings, FIGS. 1-9 illustrate a handheld electronic device holder 100. The handheld electronic device holder 100 is configured to removably secure or attach a handheld electronic device 10 to a surface, such as a wall, a mirror, a window, and the like as illustrated in FIG. 1. The surface may be horizontally or vertically oriented, tilted or angled, or curved. The handheld electronic device 10 may be a smartphone, a cell phone a tablet, a global positioning device, a digital music player, an electronic display, an electronic digital assistant, or any other similar handheld electronic screen device.

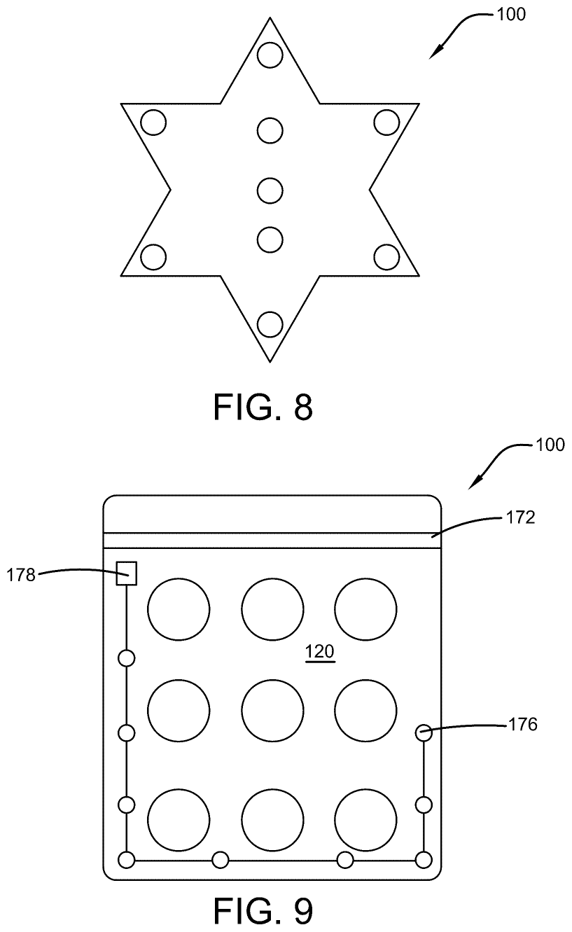

The handheld electronic device holder 100 may be rectangular in shape and of an appropriate size to fit standard smartphones, although shape and size may vary to suit the needs of the user or upon manufacturing. In different embodiments, handheld electronic device holder 100 may be any geometric shape, in the shape of another item, logo, character, rectangular, square, star shaped as illustrated in FIG. 8, irregular in shape, or any design desired. The handheld electronic device holder 100 is preferably made from silicone, rubber or rubber-like material, plastic, metal composite, and the like, although any material deemed suitable for the purpose described may be used. In different embodiments the handheld electronic device holder 100 may also be of any color, pattern, may have different textures, or may be fluorescent.

As illustrated in FIG. 2, the handheld electronic device holder 100 comprises a top 102, a bottom 110, and a pair of sides 112. The dimensions of the handheld electronic device holder 100 are sized to fit within a footprint of a back surface of the handheld electronic device 10. The handheld electronic device holder 100 further comprises a front surface 120 and a back surface 140. The front surface 120 comprises a plurality of front securing elements 130. The back surface 140 comprises a plurality of back securing elements 150.

The front securing elements 130 are configured to removably attach the front surface 120 of the handheld electronic device holder 100 to the handheld electronic device 10. The back securing elements 150 are configured to removably attach the back surface 140 of the handheld electronic device holder 100 to the surface, such as a wall, a mirror, a window, and the like. The plurality of front and back securing elements 130 and 150 secure may secure the handheld electronic device holder 100 via suction, adhesively, magnetically, or mechanically. The plurality of front and back securing elements 130 and 150 may be suction cups, adhesive fasteners, magnetic fasteners, hook and loop fasteners, or the like.

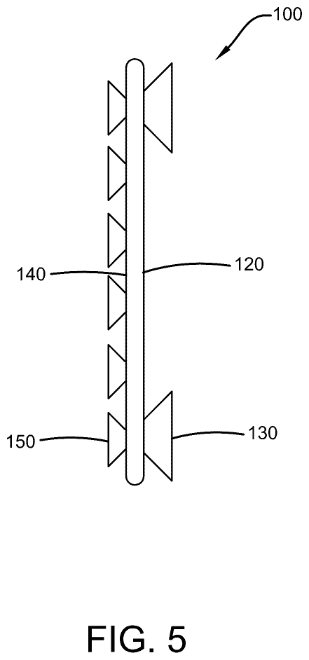

The suction cup securing elements 130 and 150 may be of different sizes, configurations, different suction strength, arrangements on the respective surface 120 and 140, and may be removably attachable to the respective surface 120 and 140. The suction cup securing elements 130 and 150 may be oval, rounded, bellows, or configured to engage a curved surface. For example, as illustrated in FIG. 5, the plurality of front securing elements 130 may be suction cups of a first size and the back securing elements 150 may be suction cups of a different size. Similarly, the front or back suction cups 130 and 150 may each have different sized suction cups on a respective surface 120 and 140. The suction cup securing elements 130 and 150 may also be removably attached to the respective surface 120 and 140 and be interchangeable and rearrangeable to create different patterns or to change the strength of the suction on the respective surface 120 or 140.

As illustrated in FIG. 7, the front or back suction cups 130 and 150 may be differently sized along a length of the respective surface 120 and 140. This would allow the handheld electronic device holder 100 to attach to the surface at an angle or slant. The front or back suction cups 130 and 150 may similarly be sized along the length of the respective surface 120 and 140 to accommodate a curved surface.

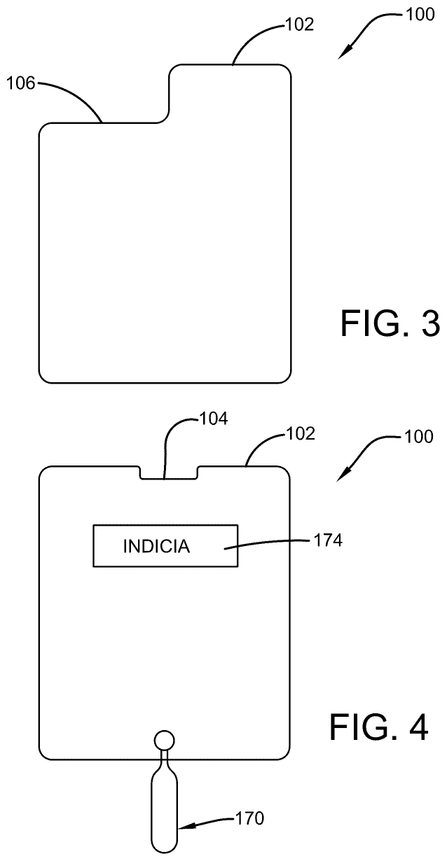

As illustrated in FIG. 3, the top 102 may comprise a cutout 106. The cutout 106 is configured to fit around a camera of the handheld electronic device 10. As illustrated in FIG. 4, the top 102 may comprise a notch 104. The handheld electronic device holder 100 may further comprise an indicia 174. The indicia 174 may be a logo, a brand, characters, letters, symbols, an image, or the like and may be on either the front surface 120, the back surface 140, or both. The handheld electronic device holder 100 may further comprise a strap 170. The strap 170 may be positioned adjacent to the bottom 110 of the handheld electronic device holder 100.

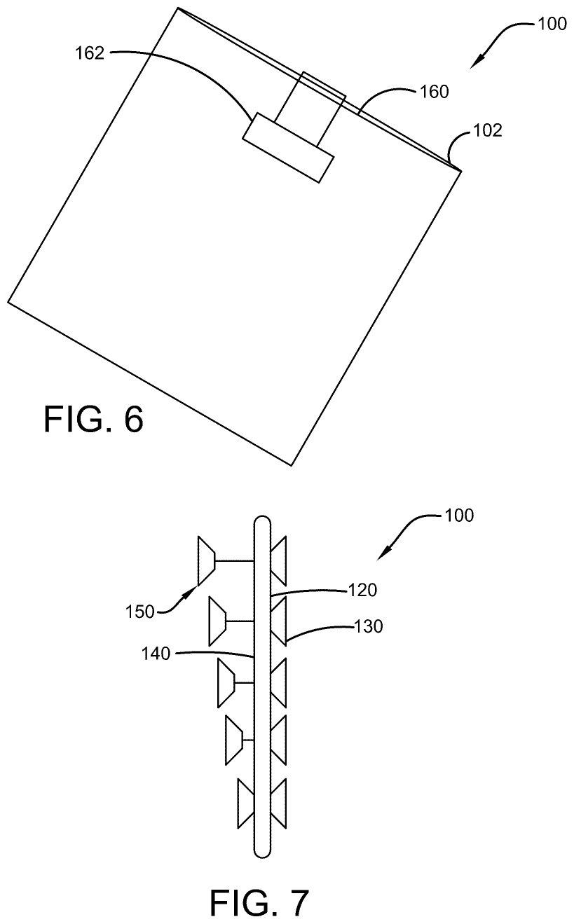

As illustrated in FIG. 6, the handheld electronic device holder 100 may further comprise a pocket 160. The pocket 160 is disposed between the front and back surfaces 120 and 140 and is open at the top 102 of the handheld electronic device holder 100. The pocket 160 is configured to hold flat objects, such as folded money, credit cards, identification cards, and the like. The pocket 160 may be lined to make it easier to slide objects in and out of the pocket. The handheld electronic device holder 100 may further comprise a securing element 160. The securing element 162 may be a strap, a magnetic closure, a snap, a mechanical fastener, a hook and loop fastener, or the like disposed at the top 102 adjacent to the pocket 160 opening to secure the pocket 160.

As illustrated in FIG. 9, the handheld electronic device holder 100 may further comprise a reflective element 172. The reflective element 172 may be a reflective tape or sticker disposed on or attachable to the front or back surfaces 120 and 140. The handheld electronic device holder 100 may further comprise a lighting element 176 and a battery 178 in electric communication with the battery. The lighting element 176 may be a plurality of light emitting diodes or a lighting strip disposed within or externally attached to the front surface 120.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “removable hands-free phone-holding device” and “device” are interchangeable and refer to the handheld electronic device holder 100 of the present invention.

Notwithstanding the forgoing, the forgoing, the handheld electronic device holder 100 of the present invention and its various components can be of any suitable size and configuration as is known in the art without affecting the overall concept of the invention, provided that they accomplish the above-stated objectives. One of ordinary skill in the art will appreciate that the size, configuration, and material of the handheld electronic device holder 100 as shown in the FIGS. are for illustrative purposes only, and that many other sizes and shapes of the handheld electronic device holder 100 are well within the scope of the present disclosure. Although the dimensions of the handheld electronic device holder 100 are important design parameters for user convenience, the handheld electronic device holder 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A handheld electronic device holder for attaching a handheld electronic device to a surface, the handheld electronic device holder comprising:
a top;
a bottom;
a pair of sides;
a front surface comprising a plurality of front securing elements; and
a back surface comprising a plurality of back securing elements; and
wherein the front securing elements are configured to removably attach the front surface to the handheld electronic device and the back securing elements are configured to removably attach the back surface to the surface.

2. The handheld electronic device holder of claim 1, wherein the plurality of front and back securing elements secure via suction.

3. The handheld electronic device holder of claim 1, wherein the plurality of front and back securing elements secure adhesively.

4. The handheld electronic device holder of claim 1, wherein the plurality of front and back securing elements secure magnetically.

5. The handheld electronic device holder of claim 1, wherein the plurality of front and back securing elements are suction cups.

6. The handheld electronic device holder of claim 1, wherein the plurality of front securing elements are suction cups of a first size and the back securing elements are suction cups of a different size.

7. The handheld electronic device holder of claim 1, wherein the plurality of front securing elements are suction cups comprising at least two different sizes.

8. The handheld electronic device holder of claim 1, wherein the plurality of front and back securing elements are removably attached to the respective front and back surfaces.

9. The handheld electronic device holder of claim 1 further comprising an indicia on either the front or back surfaces.

10. The handheld electronic device holder of claim 1, wherein the top comprises a notch.

11. The handheld electronic device holder of claim 1, wherein the top comprises a cutout configured to fit around a camera of the handheld electronic device.

12. A handheld electronic device holder for attaching a handheld electronic device to a surface, the handheld electronic device holder comprising:
a top;
a bottom;
a pair of sides;
a front surface comprising a plurality of front suction cups;
a back surface comprising a plurality of back suction cups; and
a pocket disposed between the front and back surfaces comprising an opening in the top; and
wherein the front suction cups are configured to removably attach the front surface to the handheld electronic device and the back suction cups are configured to removably attach the back surface to the surface.

13. The handheld electronic device holder of claim 12, wherein the front suction cups are smaller than the back suction cups.

14. The handheld electronic device holder of claim 12, wherein the front suction cups comprise at least two different sizes.

15. The handheld electronic device holder of claim 12, wherein the pocket is lined.

16. The handheld electronic device holder of claim 11, wherein the pocket comprises a securing element.

17. The handheld electronic device holder of claim 12, wherein the wherein the plurality of front and back suction cups are removably attached to the respective front and back surfaces.

18. A handheld electronic device holder for attaching a handheld electronic device to a surface, the handheld electronic device holder comprising:
a top;
a bottom;
a pair of sides;
a front surface comprising a plurality of front suction cups;
a back surface comprising a plurality of back suction cups; and
a lighting element disposed within the front surface; and
wherein the front suction cups are configured to removably attach the front surface to the handheld electronic device and the back suction cups are configured to removably attach the back surface to the surface.

19. The handheld electronic device holder of claim 17 further comprising a battery in electrical communication with the lighting element.

20. The handheld electronic device holder of claim 17 further comprising a reflective element disposed on the front surface.
